(19) United States
(12) Patent Application Publication
(10) Pub. No.: US 2015/0346388 A1
(43) Pub. Date: Dec. 3, 2015

(54) OPTICAL MULTILAYERED UNIT AND DISPLAY DEVICE INCLUDING THE SAME

(71) Applicant: SAMSUNG DISPLAY CO., LTD., Yongin-City (KR)

(72) Inventors: Sang Woo HAN, Cheonan-si (KR); Hyun Hee LEE, Seoul (KR); Kyung Man KIM, Cheonan-si (KR); Dong Ho LEE, Cheonan-si (KR); Sang Hee LEE, Hwaseong-si (KR); Kyong Bin JIN, Suwon-si (KR)

(21) Appl. No.: 14/494,675

(22) Filed: Sep. 24, 2014

(30) Foreign Application Priority Data
May 30, 2014 (KR) 10-2014-0066136

(51) Int. Cl. G02B 1/11; G02B 27/00; G02B 1/10

(52) U.S. Cl. CPC G02B 1/11; G02B 1/105; G02B 27/0006

(57) ABSTRACT

An optical multilayered unit including a base material; a first refractive layer on at least one surface of the base material, the first refractive layer including a fluorine-containing compound; and a second refractive layer on one surface of the first refractive layer, the second refractive layer having a refractive index that is 0.01 to 0.3 higher than a refractive index of the first refractive layer.

### CROSS-REFERENCE TO RELATED APPLICATIONS

Korean Patent Application No. 10-2014-0066136, filed on May 30, 2014 in the Korean Intellectual Property Office, and entitled: “Optical Multilayered Unit and Display Device Including the Same,” is incorporated by reference herein in its entirety.

### BACKGROUND

1. Field

Embodiments relate to an optical multilayered unit and a display device including the same.

2. Description of the Related Art

A display device may be for information display technology. An example of a display device may include a liquid crystal display that displays information in a manner in which voltages are applied to liquid crystals (that are between glass substrates) through electrodes on upper and lower portions of the glass substrates. Thus, the arrangement directions of the liquid crystals may be changed to pass or reflect light.

### SUMMARY

Embodiments are directed to an optical multilayered unit and a display device including the same.

The embodiments may be realized by providing an optical multilayered unit including a base material; a first refractive layer on at least one surface of the base material, the first refractive layer including a fluorine-containing compound; and a second refractive layer on one surface of the first refractive layer, the second refractive layer having a refractive index that is 0.01 to 0.3 higher than a refractive index of the first refractive layer.

The base material may include glass, sapphire, polymethylmethacrylate resin, polycarbonate resin, polyethylene terephthalate resin, acrylonitrile-butadiene-styrene resin, polyimide resin, polyethylene resin, or silsesquioxane resin.

The refractive index of the first refractive layer may be 1.3 to 1.39.

The first refractive layer may include MgF₂, AlF₃, Na₃AlF₆, Na₅Al₃F₁₄, LiF, CaF₂, BaF₂, YF₃, YbF₃, PrF₃, or a mixture thereof.

A thickness of the first refractive layer may be about 5 nm to about 260 nm.

The refractive index of the second refractive layer may be 1.4 to 1.54.

The second refractive layer may include SiO₂, a mixture of SiO₂ and Al₂O₃, or polymethylmethacrylate.

A thickness of the second refractive layer may be about 1 nm to about 50 nm.

The optical multilayered unit may further include a functional coating layer on an upper side of the second refractive layer, the upper side of the second refractive layer being opposite to a side of the second refractive layer that faces the first refractive layer, wherein the functional coating layer includes an anti-fingerprint coating, an anti-electrostatic coating, or an anti-glare coating.

The optical multilayered unit may further include a third refractive layer between the base material and the first refractive layer, the third refractive layer having a refractive index of 1.35 to 2.15.

The third refractive layer may include MgF₂, AlF₃, Na3AlF₆, Na₅Al₃F₁₄, PrF₃, LiF, CaF₂, BaF₂, YF₃, YbF₃, Al₂O₃, MgO, SnO₂, Y₂O₃, NdF₃, Bi₂O₃, HfO₂, ZnO, Sb₂O₃, Si₃N₄, ZrO₂, Ta₂O₅, TiO₂, Ti₃O₅, Ti₂O₃, Nb₂O₅, CeO₂, or a mixture thereof.

A thickness of the third refractive layer may be about 20 nm to about 230 nm.

The optical multilayered unit may have a reflection rate that is equal to or lower than about 3% in a visible light wavelength range.

The optical multilayered unit may have an average refection rate that is equal to or lower than about 2% in the visible light wavelength range.

A surface hardness of the optical multilayered unit may be equal to or harder than 6H.

The embodiments may be realized by providing an optical multilayered unit including a base material; a first refractive layer on at least one surface of the base material, the first refractive layer having a refractive index of 1.3 to 1.39; and a second refractive layer on one surface of the first refractive layer, the second refractive layer having a refractive index that is 0.01 to 0.3 higher than the refractive index of the first refractive layer.

The first refractive layer may include MgF₂, AlF₃, Na₃AlF₆, Na₅Al₃F₁₄, LiF, CaF₂, BaF₂, YF₃, YbF₃, PrF₃, or a mixture thereof, and the first refractive layer may have a thickness of about 5 nm to about 260 nm.

The second refractive layer may include SiO₂, a mixture of SiO₂ and Al₂O₃, or polymethylmethacrylate, and the second refractive layer may have a thickness of about 1 nm to about 50 nm.

A surface hardness of the optical multilayered unit may be equal to or harder than 6H.

The optical multilayered unit may further include a third refractive layer between the base material and the first refractive layer, wherein the third refractive layer includes MgF₂, AlF₃, Na3AlF₆, Na₅Al₃F₁₄, PrF₃, LiF, CaF₂, BaF₂, YF₃, YbF₃, Al₂O₃, MgO, SnO₂, Y₂O₃, NdF₃, Bi₂O₃, HfO₂, ZnO, Sb₂O₃, Si₃N₄, ZrO₂, Ta₂O₅, TiO₂, Ti₃O₅, Ti₂O₃, Nb₂O₅, CeO₂, or a mixture thereof, and the third refractive layer has a thickness of about 20 nm to about 230 nm.

### BRIEF DESCRIPTION OF THE DRAWINGS

Features will be apparent to those of skill in the art by describing in detail exemplary embodiments with reference to the attached drawings in which:

FIG. 1 illustrates a cross-sectional view of an optical multilayered unit according to an embodiment;

FIG. 2 illustrates a cross-sectional view of an optical multilayered unit according to another embodiment;

FIG. 3 illustrates a cross-section view of an optical multilayered unit according to still another embodiment;

FIG. 4 illustrates a cross-section view of an optical multilayered unit according to still another embodiment;

FIG. 5 illustrates a perspective view schematically showing a display device including an optical multilayered unit according to an embodiment;

FIG. 6 illustrates a graph comparatively showing the results of Measurement Examples 1 and 2; and

FIGS. 7 to 15 illustrate graphs showing a comparison of the reflection rates of optical multilayered units according to Experimental Examples 1 to 9 with the reflection rate of a Comparative Experimental Example.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

The term “on” that is used to designate that an element is on another element located on a different layer or a layer includes both a case where an element is located directly on another element or a layer and a case where an element is located on another element via another layer or still another element.

Although the terms “first, second, and so forth” are used to describe diverse constituent elements, such constituent elements are not limited by the terms. The terms are used only to discriminate a constituent element from another constituent element. Accordingly, in the following description, a first constituent element may be a second constituent element.

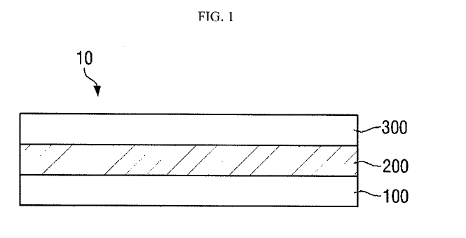

FIG. 1 illustrates a cross-sectional view of an optical multilayered unit according to an embodiment.

Referring to FIG. 1, an optical multilayered unit 10 according to an embodiment may include a base material 100, a first refractive layer 200 on at least one surface of the base material 100 (and including a fluorine-containing compound), and a second refractive layer 300 on one surface of the first refractive layer 200. The second refractive layer 300 may have a refractive index that is higher than a refractive index of the first refractive layer 200 by, e.g., 0.01 to 0.3. For example, the refractive index of the second refractive layer 300 may be 0.01 to 0.3 higher than the refractive index of the first refractive layer 200.

The base material 100 may include, e.g., glass, sapphire, polymethyl methacrylate (PMMA) resin, polycarbonate (PC) resin, polyethylene terephthalate (PET) resin, acrylonitrile-butadiene-styrene (ABS) resin, polyimide (PI) resin, polyethylene (PE) resin, or silsesquioxane resin. Accordingly, the optical multilayered unit according to an embodiment may be applied to not only a general display device of a rigid material but also a display device of a flexible material.

The refractive index of the first refractive layer 200 may be 1.3 to 1.39. For example, the refractive index of the first refractive layer 200 at a wavelength of 550 nm may be 1.3 to 1.39. A surface reflection rate of the optical multilayered unit 10 may be effectively reduced when the refractive index of the first refractive layer 200 is within the above-described. Accordingly, difficultly in seeing a displayed image due to the reflection of light that is incident from the outside onto the optical multilayered unit 10 of the display device may be effectively avoided.

As noted above, the first refractive layer 200 may include a fluorine-containing compound. In an implementation, the fluorine-containing compound may include, e.g., MgF₂, AlF₃, Na₃AlF₆, Na₅Al₃F₁₄, LiF, CaF₂, BaF₂, YF₃, YbF₃, PrF₃, or a mixture thereof.

The refractive index of the second refractive layer 300 may be slightly higher than the refractive index of the first refractive layer 200. In an implementation, the refractive index of the second refractive layer 300 may be higher than the refractive index of the first refractive layer 200 by 0.01 to 0.3, e.g., the refractive index of the second refractive layer 300 at the wavelength of 550 nm may be higher than the refractive index of the first refractive layer 200 by 0.01 to 0.3. By making the refractive index of the second refractive layer 300 slightly higher than the refractive index of the first refractive layer 200, the reflection rate of the surface of the optical multilayered unit may be reduced. Further, the difference between the refractive indexes of the first refractive layer 200 and the second refractive layer 300 may be slight, and an increase in the surface reflection rate of the optical multilayered unit may be prevented, even if the second refractive layer 300 is damaged by an external impact or scratches.

In an implementation, the refractive index of the second refractive layer 300 may be 1.4 to 1.54, e.g., the refractive index at a wavelength of 550 nm may be 1.4 to 1.54. Accordingly, the light that is incident from the outside to the optical multilayered unit 10 of the display device may not be reflected.

The second refractive layer 300 may include, e.g., SiO₂, a mixture of SiO₂ and Al₂O₃, or PMMA.

The second refractive layer 300 may be made of the above-described material, and may serve as a primer layer for improving adhesion of a functional coating layer that is positioned on the second refractive layer 300.

In an implementation, a thickness of the first refractive layer 200 may be about 5 nm to about 260 nm. In an implementation, a thickness of the second refractive layer 300 may be about 1 nm to about 50 nm. Within the above-described range, the reflection rate of the optical multilayered unit 10 may be advantageously reduced.

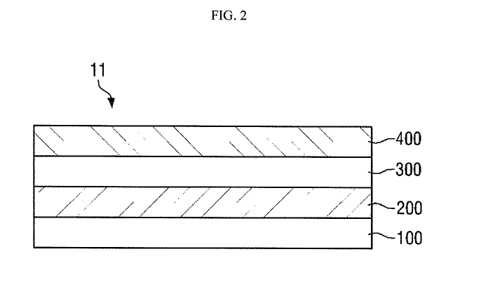

FIG. 2 illustrates a cross-sectional view of an optical multilayered unit 11 according to another embodiment. Referring to FIG. 2, an optical multilayered unit 11 may further include a functional coating layer 400 on an upper side of the second refractive layer 300. For example, the functional coating layer 400 may be on a side of the second refractive layer 300 that is opposite to the side of the second refractive layer 300 that faces the first refractive layer 200. In an implementation, the functional coating layer 400 may include, e.g., an anti-fingerprint (AF) coating, an anti-electrostatic coating, or an anti-glare coating.

The functional coating layer 400 may be easily combined with the optical multilayered unit by the medium of the second refractive layer 300. For example, the second refractive layer 300 may serve as a primer layer that facilitates coupling or combining of the functional coating layer 400 with the optical multilayered unit.

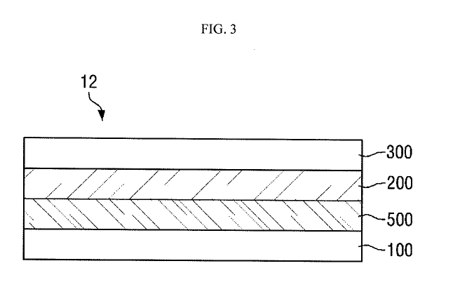

FIG. 3 illustrates a cross-section view of an optical multilayered unit 12 according to still another embodiment. Referring to FIG. 3, an optical multilayered unit 12 may further include a third refractive layer 500 between the base material 100 and the first refractive layer 200. In an implementation, the refractive index of the third refractive layer 500 may be 1.35 to 2.15, e.g., the refractive index at a wavelength of 550 nm may be 1.35 to 2.15. The third refractive layer 500 may help reduce the reflection rate of the optical multilayered unit 12 through prevention of the light incident from the outside from being reflected by destructive interference with the first refractive layer 200.

The third refractive layer 500 may help improve cohesion or adhesion between the base material 100 and other refractive layers through improvement of mutual adhesion with the base material 100. Accordingly, impact resistance of the optical multilayered unit 12 may be improved, and the reflection rate may be effectively reduced.

The third refractive layer 500 may include, e.g., MgF₂, AlF₃, Na3AlF₆, Na₅Al₃F₁₄, PrF₃, LiF, CaF₂, BaF₂, YF₃, YbF₃, Al₂O₃, MgO, SnO₂, Y₂O₃, NdF₃, Bi₂O₃, HfO₂, ZnO, Sb₂O₃, Si₃N₄, ZrO₂, Ta₂O₅, TiO₂, Ti₃O₅, Ti₂O₃, Nb₂O₅, CeO₂, or a mixture thereof.

The thickness of the third refractive layer 500 may be, e.g., about 20 nm to about 230 nm. Through combination of the base material 100 with the upper refractive layers within the above-described range, the reflection rate of the optical multilayered unit 12 may be effectively reduced.

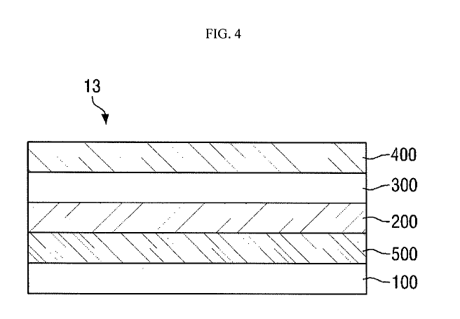

FIG. 4 illustrates a cross-section view schematically illustrating an optical multilayered unit 13 according to still another embodiment. Referring to FIG. 4, an optical multilayered unit 13 may have a structure in which the third refractive layer 500, the first refractive layer 200, the second refractive layer 300, and the functional coating layer 400 are sequentially laminated on the base material 100. The base material 100, the third refractive layer 500, the first refractive layer 200, the second refractive layer 300, and the functional coating layer have been described in detail, and a repeated explanation thereof may be omitted.

In an implementation, the reflection rate of the optical multilayered unit in a wavelength range of visible light may be within or less than about 3%, e.g., within or less than 2%. In an implementation, an average reflection rate of the optical multilayered unit in the wavelength range of the visible light may be within or less than about 2%, e.g., within or less than about 1%. The wavelength range of the visible light may generally be in the range of 400 to 700 nm, and may mean the light in the wavelength range that may be perceived by the eye.

According to an embodiment, through implementation of the reflection rate described above, the reflection of the light that is incident from the outside may be minimized, and inconvenience due to the reflected light may be reduced in viewing the image displayed on the display device.

For example, by forming a small number of refractive layers and reducing the difference in refractive index between the refractive layers, the reflection rate in a region where scratches occur may be prevented from being abruptly increased even if the scratches occur.

The optical multilayered unit according to an embodiment may help improve the permeability of the optical multilayered unit by about 3% through reduction of the reflection rate as described above, and thus may help reduce the power consumption of a battery. The optical multilayered unit according to an embodiment may help improve the bright room contrast ratio by 70% or more through reduction of the reflection rate, and thus may help increase the visibility outdoors.

In an implementation, a surface hardness of the optical multilayered unit may be equal to or harder than 6H, e.g., may be equal to or harder than 8H or 9H. Accordingly, anti-scratching properties of the optical multilayered unit may be increased.

For example, the surface hardness of the optical multilayered unit may be a numerical value that is measured by the International Standards, ISO-15184 (Paints and varnishes—Determination of film hardness by pencil test) using a motorized pencil hardness tester.

According to another embodiment, the optical multilayered unit may include a base material, a first refractive layer on at least one surface of the base material (and having a refractive index of 1.3 to 1.39), and a second refractive layer on an upper surface of the first refractive layer (e.g., opposite to the base material, and having a refractive index that is higher than the refractive index of the first refractive layer by 0.01 to 0.3). For example, the refractive indexes of the first refractive layer and the second refractive layer may be refractive indexes at a wavelength of 550 nm.

The optical multilayered unit may further include a third refractive layer between the first refractive layer and the base material. The third refractive layer may include, e.g., MgF₂, AlF₃, Na3AlF₆, Na₅Al₃F₁₄, PrF₃, LiF, CaF₂, BaF₂, YF₃, YbF₃, Al₂O₃, MgO, SnO₂, Y₂O₃, NdF₃, Bi₂O₃, HfO₂, ZnO, Sb₂O₃, Si₃N₄, ZrO₂, Ta₂O₅, TiO₂, Ti₃O₅, Ti₂O₃, Nb₂O₅, CeO₂, or a mixture thereof. The thickness of the third refractive layer may be, e.g., about 20 nm to about 230 nm.

The first refractive layer may include, e.g., MgF₂, AlF₃, Na₃AlF₆, Na₅Al₃F₁₄, LiF, CaF₂, BaF₂, YF₃, YbF₃, PrF₃, or a mixture thereof, and the thickness thereof may be, e.g., about 5 nm to about 260 nm. The second refractive layer 300 may include, e.g., SiO₂, a mixture of SiO₂ and Al₂O₃, or a polymethyl methacrylate (PMMA) resin, and the thickness thereof may be, e.g., about 1 nm to about 50 nm.

A functional coating layer, e.g., an anti-fingerprint (AF) coating, an antistatic coating, or an antiglare coating, may be further provided on an upper portion of the second refractive layer. The base material, the first refractive layer, the second refractive layer, the third refractive layer, and the functional coating layer have been described in detail, and a repeated description thereof may be omitted.

The optical multilayered unit according to an embodiment may be manufactured by an E-beam deposition method. For example, the base material may be put into a vacuum deposition chamber, and respective refractive layers may be sequentially formed by an E-beam deposition device in the chamber. In an implementation, in the case of forming the first refractive layer and the second refractive layer on the base material, the material of the first refractive layer may be first deposited with a predetermined thickness, and then the second refractive layer may be formed through deposition of the material of the second refractive layer.

The E-beam deposition process may include evaporating samples using heat that is generated when thermions generated from a hot cathode of an electron gun collide with the samples that are accelerated by high voltage, and may be similar to the principle of the electron gun that is used in a cathode ray tube (CRT). The equipment configuration may include an electron gun that emits electrons and an electron beam power supply device.

The E-beam deposition method may be used as a method for depositing a thin film because of its advantages, e.g., high evaporation rate, high thermal efficiency, economical efficiency, control easiness, and cleanness.

In addition to, or as an alternative to, the E-beam deposition method, the respective refractive layers may be formed using various suitable methods, e.g., sputter deposition and thermal deposition.

The optical multilayered unit according to an embodiment may formed of or may include only a small number of refractive layers, e.g., two or three refractive layers, and the production time of the optical multilayered unit may be shortened to help improve the productivity. Further, a small number of refractive layers may be formed, and a product inferiority rate can be reduced.

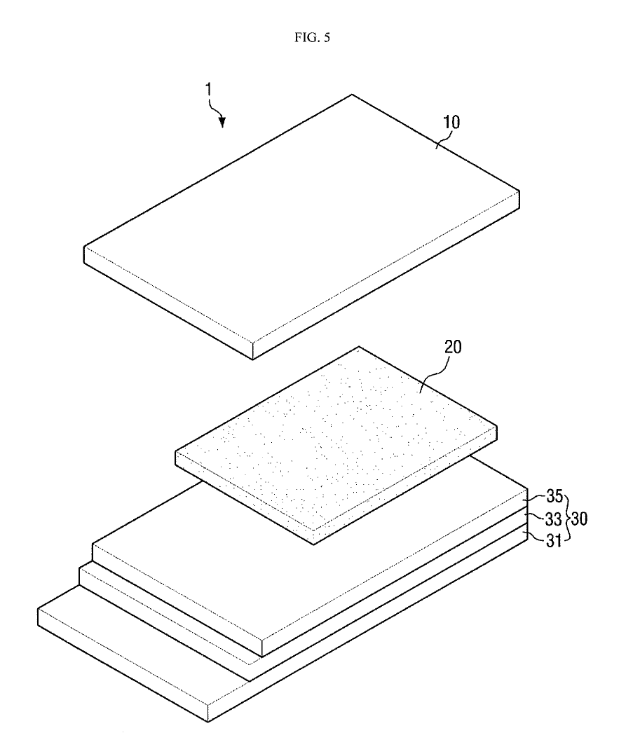

The embodiments provide a display device that includes the optical multilayered unit as described above. FIG. 5 illustrates a schematic perspective view of a display device according to an embodiment.

Hereinafter, referring to FIG. 5, a display device according to an embodiment will be described.

Referring to FIG. 5, a display device 1 may include a backlight unit (not illustrated), a display module 30, and an optical multilayered unit 10 that is bonded to an upper side of the display module 30 with a bonding member 20. The optical multilayered unit 10 may be formed as the optical multilayered unit according to an embodiment as described above.

The display module 30 may include a first substrate 31 and a second substrate 33 that face each other. If the display module 30 includes liquid crystals, the liquid crystals may be positioned between the first substrate 31 and the second substrate 33. In an implementation, in the case where the display module 30 includes an organic light emitting diode, the organic light emitting diode may be positioned between the first substrate 31 and the second substrate 33.

For example, the display module 30 may include a display panel that includes the first substrate 31 and the second substrate 33, and the kinds of display panels are not limited. As the display panel, a self-luminous display panel, such as an organic light emitting device (OLED) panel, may be used. Further, a non-luminous display panel, such as a liquid crystal display (LCD) panel, an electrophoretic display (EPD) panel, or an electrowetting display (EWD) panel, may be used. If the non-luminous display panel is used as the display panel, the display module 300 may further include a backlight unit that supplies light to the display panel.

The first substrate 31 and the second substrate 33 may be bonded together by a sealant (not illustrated) that may be arranged along an edge of the second substrate 33. The display device 1 may include an integrated circuit chip or a driving circuit, which processes and transfers a signal input from an outside to the display module 30 to display an image, and the first substrate 31 may include pixels that are arranged in the form of a matrix.

The display module 30 may include a touch panel 35 that is positioned on the upper portions of the first substrate 31 and the second substrate 33, and the touch panel 35 may recognize a touch, e.g., by way of a touch or press device, such as a pen or a user's finger, and may transfer a signal that corresponds to a position where the touch is performed to a touch driving portion (not illustrated). The touch panel 35 may be used as an inputter for the display device 1. In an implementation, the touch panel 35 may sense the touch through various suitable methods, e.g., capacitive overlay, resistive overlay, infrared beam, integral strain gauge, surface acoustic wave, or piezoelectric.

The optical multilayered unit 10 may be positioned on the display module 30. The optical multilayered unit 10 may be positioned on the display module 30 in the direction or on a side in which an image is emitted to face the display module 30. Further, the bonding member 20 may be positioned between the optical multilayered unit 10 and the display module 30. The bonding member 20 may bond the second substrate 33 or touch panel 35 of the display module 30 with the optical multilayered unit 20, and may help prevent the display module 30 from being damaged due to an external impact to improve the impact resistance. In an implementation, a light blocking member (not illustrated) may be further provided between the optical multilayered unit 20 and the display module 30.

In the case where the display device 1 includes a backlight unit (not illustrated) that supplies light to the display module 30, the backlight unit may include a light source (not illustrated) and an optical sheet (not illustrated). The optical sheet may include a diffusion sheet, a prism sheet, a reflective sheet, and a protection sheet for improving the optical performance of the display device 1, or a light guide panel that guides a light path.

Further, although not illustrated, the display device may include a lower chassis accommodating constituent elements of the display device, a middle frame on which the display module is put, and a top chassis combined with the lower chassis to fix the constituent elements provided therein.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### MANUFACTURING EXAMPLE

A first refractive layer (made of MgF₂) was formed to a thickness of 66.86 nm on a glass substrate having a refractive index of 1.52. A second refractive layer (made of SiO₂) was formed on an upper portion or side of the first refractive layer and had a thickness of 15.3 nm. A third refractive layer (made of Al₂O₃) was formed between the glass substrate and the first refractive layer, and had a thickness of 136.32 nm, to produce the optical multilayered unit.

### EXPERIMENTAL EXAMPLES

In the Experimental Examples below, the reflection rates of materials that form the refractive layers were predicted through an input of respective refractive indexes, the materials that form the refractive layers, and thickness values thereof using the essential Macleod simulation program. For example, the Experimental Examples were theoretical calculations and were compared with the Manufacturing Example above that was manufactured and tested.

### Experimental Example 1

The first refractive layer had a thickness of 78.51 nm, was made of Na₃AlF₆, and was on a glass substrate having a refractive index of 1.519, and the second refractive layer had a thickness of 10 nm, was made of SiO₂ and was on the upper portion the first refractive layer.

### Experimental Example 2

The first refractive layer was made of MgF₂, had a thickness of 47.45 nm, and was on a glass substrate having a refractive index of 1.519, and the second refractive layer was made of SiO₂, was on the upper portion of the first refractive layer, and had a thickness of 10 nm. Further, the third refractive layer was made of AlF₃, was between the glass substrate and the first refractive layer, and had a thickness of 35 nm.

### Experimental Example 3

The first refractive layer was made of MgF₂, was on a glass substrate having a refractive index of 1.519, and had a thickness of 44.33 nm, and the second refractive layer was made of SiO₂, was on the upper portion of the first refractive layer, and had a thickness of 10 nm. Further, the third refractive layer was made of Ta₂O₅, was between the glass substrate and the first refractive layer, and had a thickness of 118.07 nm.

### Experimental Example 4

The first refractive layer was made of MgF₂, was on a glass substrate having a refractive index of 1.519, and had a thickness of 76.45 nm, and the second refractive layer was made of SiO₂, was on the upper portion of the first refractive layer, and had a thickness of 10 nm. Further, the third refractive layer was made of PrF₃, was between the glass substrate and the first refractive layer, and had a thickness of 228.44 nm.

### Experimental Example 5

The first refractive layer was made of Na₃AlF₆, was on a glass substrate having a refractive index of 1.519, and had a thickness of 91.18 nm, and the second refractive was layer made of SiO₂, was on the upper portion of the first refractive layer, and had a thickness of 10 nm. Further, the third refractive layer was made of Al₂O₃, was between the glass substrate and the first refractive layer, and had a thickness of 24.21 nm.

### Experimental Example 6

The first refractive layer was made of Na₃AlF₆, was one a glass substrate having a refractive index of 1.519, and had a thickness of 256.02 nm, and the second refractive layer was made of SiO₂, was on the upper portion of the first refractive layer, and had a thickness of 10 nm. Further, the third refractive layer was made of SiO₂, was between the glass substrate and the first refractive layer, and had a thickness of 78.07 nm.

### Experimental Example 7

The first refractive layer was made of MgF₂, was on a glass substrate having a refractive index of 1.519, and had a thickness of 5 nm, and the second refractive layer was made of SiO₂, was on the upper portion of the first refractive layer, and had a thickness of 10 nm. Further, the third refractive layer made of Na₃AlF₆, was between the glass substrate and the first refractive layer, and had a thickness of 88.96 nm.

### Experimental Example 8

The first refractive layer was made of MgF₂, was on a glass substrate having a refractive index of 1.519, and had a thickness of 92.88 nm, and the second refractive layer was made of SiO₂, was on the upper portion of the first refractive layer, and had a thickness of 1 nm. Further, the third refractive layer was made of Al₂O₃, was between the glass substrate and the first refractive layer, and had a thickness of 153.37 nm.

### Experimental Example 9

The first refractive layer was made of MgF₂, was on a glass substrate having a refractive index of 1.519, and had a thickness of 38.44 nm, and the second refractive layer was made of SiO₂, was on the upper portion of the first refractive layer, and had a thickness of 50 nm. Further, the third refractive layer made of PrF₃, was between the glass substrate and the first refractive layer, and had a thickness of 44.59 nm.

In order to compare errors of the resultant values derived through inputting the optical simulation, e.g., the calculations, and the actually manufactured optical multilayered unit, layers having the same numerical values, e.g., thicknesses, and materials as the numerical values of the Manufacturing Example were input to the simulation.

Materials that formed the first to third refractive layers of the optical multilayered units, refractive indexes, and thicknesses, which were input according to the Experimental Examples 1 to 10, are shown in Table 1 below.

TABLE 1

| | | | Refrac- | |
|---|---|---|---|---|
| | | | tive | Thickness |
| | Refractive Layer | Material | Index | (nm) |
| Experimental | First Refractive Layer | Na₃AlF₆ | 1.341 | 78.51 |
| Example 1 | Second Refractive Layer | SiO₂ | 1.451 | 10 |
| | Third Refractive Layer | — | — | — |
| Experimental | First Refractive Layer | MgF₂ | 1.375 | 47.45 |
| Example 2 | Second Refractive Layer | SiO₂ | 1.451 | 10 |
| | Third Refractive Layer | AlF₃ | 1.391 | 35 |
| Experimental | First Refractive Layer | MgF₂ | 1.375 | 44.33 |
| Example 3 | Second Refractive Layer | SiO₂ | 1.451 | 10 |
| | Third Refractive Layer | Ta₂O₅ | 2.144 | 118.07 |
| Experimental | First Refractive Layer | MgF₂ | 1.375 | 76.45 |
| Example 4 | Second Refractive Layer | SiO₂ | 1.451 | 10 |
| | Third Refractive Layer | PrF₃ | 1.543 | 228.44 |
| Experimental | First Refractive Layer | Na₃AlF₆ | 1.341 | 91.18 |
| Example 5 | Second Refractive Layer | SiO₂ | 1.451 | 10 |
| | Third Refractive Layer | Al₂O₃ | 1.627 | 24.21 |
| Experimental | First Refractive Layer | Na₃AlF₆ | 1.341 | 256.02 |
| Example 6 | Second Refractive Layer | SiO₂ | 1.451 | 10 |
| | Third Refractive Layer | SiO₂ | 1.451 | 78.07 |
| Experimental | First Refractive Layer | MgF₂ | 1.375 | 5 |
| Example 7 | Second Refractive Layer | SiO₂ | 1.451 | 10 |
| | Third Refractive Layer | Na₃AlF₆ | 1.341 | 88.96 |
| Experimental | First Refractive Layer | MgF₂ | 1.375 | 92.88 |
| Example 8 | Second Refractive Layer | SiO₂ | 1.451 | 1 |
| | Third Refractive Layer | Al₂O₃ | 1.627 | 153.37 |
| Experimental | First Refractive Layer | MgF₂ | 1.375 | 38.44 |
| Example 9 | Second Refractive Layer | SiO₂ | 1.451 | 50 |
| | Third Refractive Layer | PrF₃ | 1.543 | 44.59 |
| Experimental | First Refractive Layer | MgF₂ | 1.375 | 66.86 |
| Example 10 | Second Refractive Layer | SiO₂ | 1.451 | 15.3 |
| | Third Refractive Layer | Al₂O₃ | 1.627 | 136.32 |

### Comparative Experimental Example

A substrate made of glass only without forming a separate refractive layer was input for calculation.

### MEASUREMENT EXAMPLES

### Measurement Example 1

The reflection rate of the optical multilayered unit manufactured in the above-described Manufacturing Example was measured using Color i7 color meter of X-rite. The measurement was made in the unit of 10 nm on the measurement conditions of a view port size of 6 mm and a measured wavelength range of 400 nm to 750 nm using D65 light source.

### Measurement Example 2

The reflection rate values in Experimental Example 10, in which the numerical values on the same conditions as those of the above-described Manufacturing Example were input, were derived. The measured wavelength band was the visible light wavelength band.

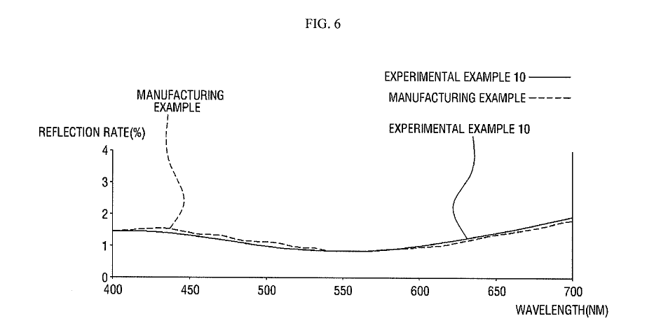

In order to examine whether the Experimental Examples using the essential Macleod simulation program, the Comparative Experimental Example, and the Measurement Examples coincide with the reflection rate value of the actually manufactured optical multilayered unit, the results according to the Measurement Example 1 and the Measurement Example 2 were compared with each other as shown in FIG. 6.

Referring to FIG. 6, it may be seen that the refection rate value of the actually manufactured optical multilayered unit was almost similar to the reflection rate value in the case where the same numerical value was input to the simulation program. Accordingly, it may be seen that the numerical values of the reflection rates predicted in the Experimental Examples 1 to 9 are reliable.

### Measurement Example 3

The reflection rates in the Experimental Examples 1 to 9 in the visible light wavelength band were derived using the essential Macleod simulation program.

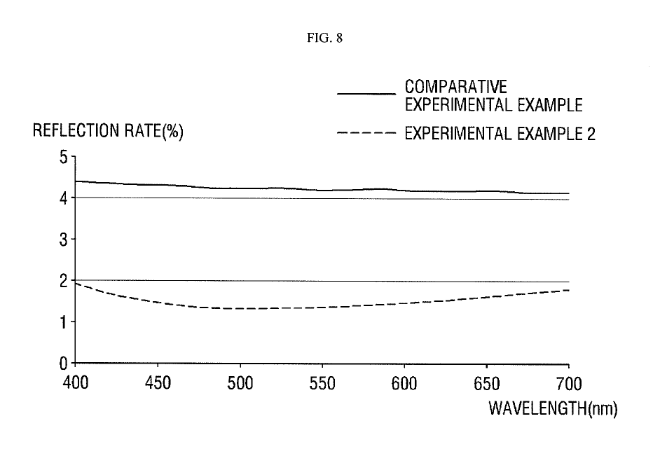

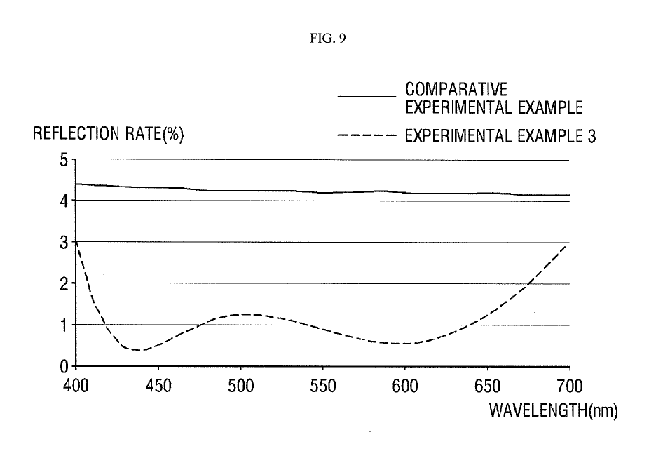

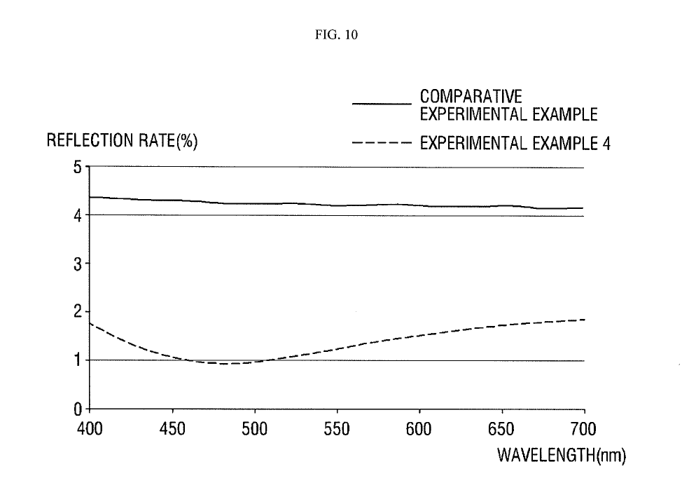

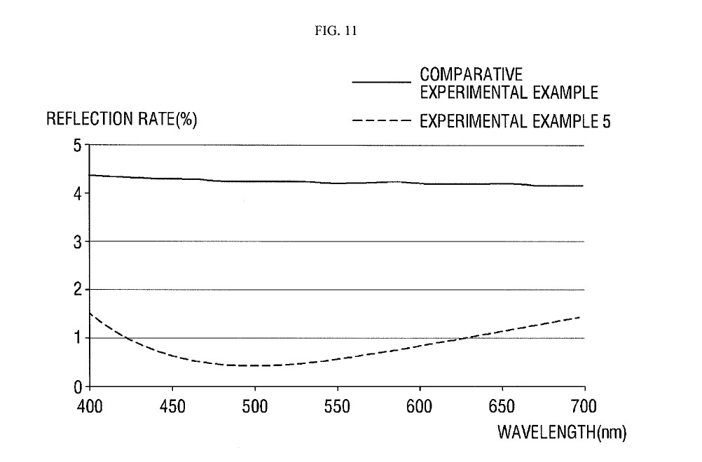

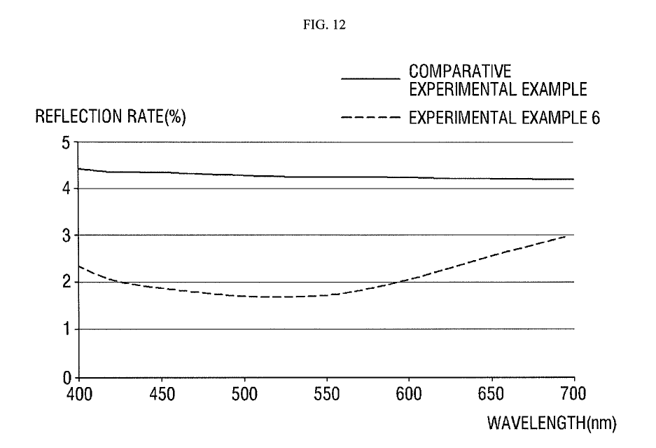

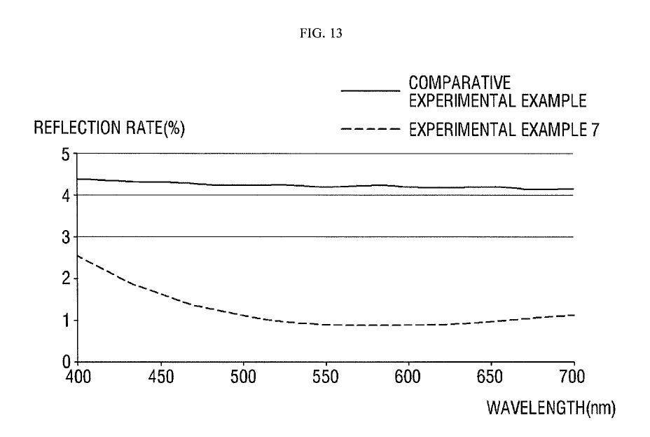

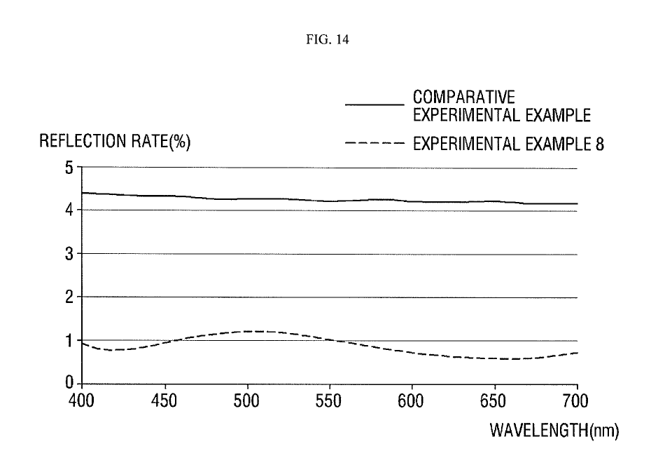

The graphs show the measurement results in the Measurement Example 3, and FIGS. 6 to 14 illustrate graphs showing the results of comparison of the reflection rates in the Experimental Examples 1 to 9 with the reflection rates in the Comparative Experimental Example.

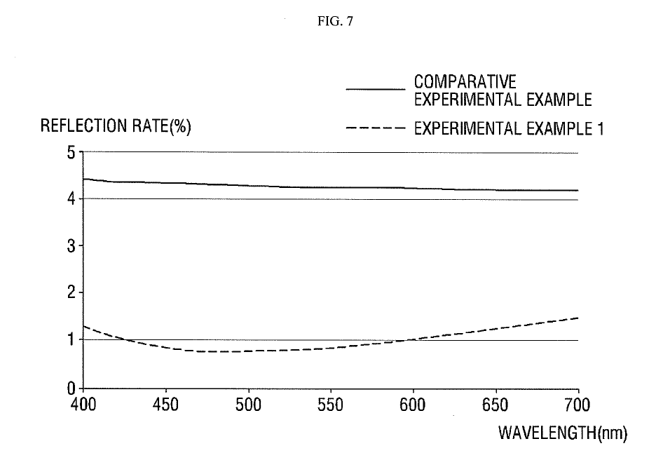

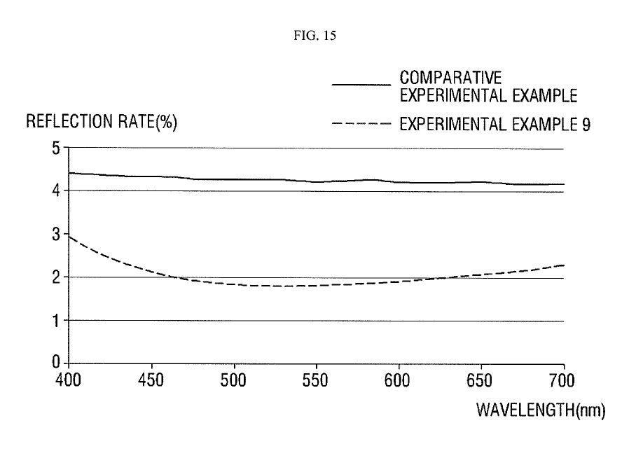

As shown in FIGS. 7 to 15, it may be seen that the reflection rate in the Comparative Experimental Example (using only the glass substrate) was equal to or higher than 4%, whereas the reflection rate of the optical multilayered unit derived in the Experimental Examples was lower than 3%. Further, it may be seen that an average reflection rate of the optical multilayered unit derived according to the Experimental Examples in the visible light wavelength band was within 2%. Accordingly, it may be seen that the optical multilayered unit according to an embodiment may help effectively reduce the reflection rate of the light that is incident from an outside.

### Measurement Example 4

The hardness of the optical multilayered unit manufactured in the above-described Manufacturing Example was measured. The measurement was made by ISO-15184 (Paints and varnishes—Determination of film hardness by pencil test) that is a method described in the International Standards using a motorized pencil hardness tester. The measurement was made using a pencil of Mitsubishi Pencil Co. under conditions of a scratch angle of 45°, applied load of 750 g, scratch speed of 1 mm/s, and scratch distance of 20 mm.

As the result of the Measurement Example 4, the scratch did not occur, even at the surface hardness of 9H or harder. Considering that the hardness of glass is about 9H, it may be seen that the optical multilayered unit according to an embodiment may have very high hardness, and thus it may be seen that the optical multilayered unit according to an embodiment may have superior anti-scratching performance.

By way of summation and review, a window may be adopted on a side surface of a display device that a viewer views, and it may be difficult for the viewer to see an image that is displayed on the display device due to reflection of light that is incident from an outside onto the window of the display device. The window may be an outermost portion of the display device that is exposed to the outside, and scratches may easily occur due to, e.g., an external impact. If the scratches occur, the reflection-preventing function may deteriorate due to a difference in reflection rate between various kinds of functional layers on the window.

In the case of an optical multilayered unit that is formed of glass only, the reflection rate in the visible light range may be 4% or more, and the average reflection rate may be about 4.2%. Accordingly, in the case the optical multilayered unit that is formed of glass only, it may be difficult to see an image due to the reflection of the light that is incident from the outside.

The embodiments may provide an optical multilayered unit that has a superior reflection-preventing function.

The embodiments may provide an optical multilayered unit that may help prevent scratches from occurring due to an external impact.

The embodiments may provide an optical multilayered unit that may help maintain a superior reflection-preventing function even if scratches occur.

According to an embodiment, it is possible to provide the optical multilayered unit that may perform the superior reflection-preventing function through reduction of the reflection rate.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An optical multilayered unit, comprising:
a base material;
a first refractive layer on at least one surface of the base material, the first refractive layer including a fluorine-containing compound; and
a second refractive layer on one surface of the first refractive layer, the second refractive layer having a refractive index that is 0.01 to 0.3 higher than a refractive index of the first refractive layer.

2. The optical multilayered unit as claimed in claim 1, wherein the base material includes glass, sapphire, polymethylmethacrylate resin, polycarbonate resin, polyethylene terephthalate resin, acrylonitrile-butadiene-styrene resin, polyimide resin, polyethylene resin, or silsesquioxane resin.

3. The optical multilayered unit as claimed in claim 1, wherein the refractive index of the first refractive layer is 1.3 to 1.39.

4. The optical multilayered unit as claimed in claim 1, wherein the first refractive layer includes MgF₂, AlF₃, Na₃AlF₆, Na₅Al₃F₁₄, LiF, CaF₂, BaF₂, YF₃, YbF₃, PrF₃, or a mixture thereof.

5. The optical multilayered unit as claimed in claim 1, wherein a thickness of the first refractive layer is about 5 nm to about 260 nm.

6. The optical multilayered unit as claimed in claim 1, wherein the refractive index of the second refractive layer is 1.4 to 1.54.

7. The optical multilayered unit as claimed in claim 1, wherein the second refractive layer includes SiO₂, a mixture of SiO₂ and Al₂O₃, or polymethylmethacrylate.

8. The optical multilayered unit as claimed in claim 1, wherein a thickness of the second refractive layer is about 1 nm to about 50 nm.

9. The optical multilayered unit as claimed in claim 1, further comprising a functional coating layer on an upper side of the second refractive layer, the upper side of the second refractive layer being opposite to a side of the second refractive layer that faces the first refractive layer, wherein the functional coating layer includes an anti-fingerprint coating, an anti-electrostatic coating, or an anti-glare coating.

10. The optical multilayered unit as claimed in claim 1, further comprising a third refractive layer between the base material and the first refractive layer, the third refractive layer having a refractive index of 1.35 to 2.15.

11. The optical multilayered unit as claimed in claim 10, wherein the third refractive layer includes MgF₂, AlF₃, Na3AlF₆, Na₅Al₃F₁₄, PrF₃, LiF, CaF₂, BaF₂, YF₃, YbF₃, Al₂O₃, MgO, SnO₂, Y₂O₃, NdF₃, Bi₂O₃, HfO₂, ZnO, Sb₂O₃, Si₃N₄, ZrO₂, Ta₂O₅, TiO₂, Ti₃O₅, Ti₂O₃, Nb₂O₅, CeO₂, or a mixture thereof.

12. The optical multilayered unit as claimed in claim 10, wherein a thickness of the third refractive layer is about 20 nm to about 230 nm.

13. The optical multilayered unit as claimed in claim 1, wherein the optical multilayered unit has a reflection rate that is equal to or lower than about 3% in a visible light wavelength range.

14. The optical multilayered unit as claimed in claim 13, wherein the optical multilayered unit has an average refection rate that is equal to or lower than about 2% in the visible light wavelength range.

15. The optical multilayered unit as claimed in claim 1, wherein a surface hardness of the optical multilayered unit is equal to or harder than 6H.

16. An optical multilayered unit, comprising:
a base material;
a first refractive layer on at least one surface of the base material, the first refractive layer having a refractive index of 1.3 to 1.39; and
a second refractive layer on one surface of the first refractive layer, the second refractive layer having a refractive index that is 0.01 to 0.3 higher than the refractive index of the first refractive layer.

17. The optical multilayered unit as claimed in claim 16, wherein:
the first refractive layer includes MgF₂, AlF₃, Na₃AlF₆, Na₅Al₃F₁₄, LiF, CaF₂, BaF₂, YF₃, YbF₃, PrF₃, or a mixture thereof, and
the first refractive layer has a thickness of about 5 nm to about 260 nm.

18. The optical multilayered unit as claimed in claim 17, wherein:
the second refractive layer includes SiO₂, a mixture of SiO₂ and Al₂O₃, or polymethylmethacrylate, and
the second refractive layer has a thickness of about 1 nm to about 50 nm.

19. The optical multilayered unit as claimed in claim 16, wherein a surface hardness of the optical multilayered unit is equal to or harder than 6H.

20. The optical multilayered unit as claimed in claim 18, further comprising a third refractive layer between the base material and the first refractive layer, wherein:
the third refractive layer includes MgF₂, AlF₃, Na3AlF₆, Na₅Al₃F₁₄, PrF₃, LiF, CaF₂, BaF₂, YF₃, YbF₃, Al₂O₃, MgO, SnO₂, Y₂O₃, NdF₃, Bi₂O₃, HfO₂, ZnO, Sb₂O₃, Si₃N₄, ZrO₂, Ta₂O₅, TiO₂, Ti₃O₅, Ti₂O₃, Nb₂O₅, CeO₂, or a mixture thereof, and
the third refractive layer has a thickness of about 20 nm to about 230 nm.
